(19) United States
(12) Patent Application Publication
(10) Pub. No.: US 2022/0127475 A1
(43) Pub. Date: Apr. 28, 2022

(54) STRUCTURAL COLORANTS WITH SILANE GROUPS

(71) Applicants: BASF Coatings GmbH, Münster (DE); President and Fellows of Harvard College, Cambridge, MA (US)

(72) Inventors: Zenon Paul CZORNIJ, Southfield, MI (US); Charles L. TAZZIA, Wyandotte, MI (US); Paragkumar THANKI, Mangalore (IN); Elijah SHIRMAN, Winchester, MA (US); Theresa M. KAY, Hamilton ON (CA); Joanna AIZENBERG, Cambridge, MA (US)

(21) Appl. No.: 17/438,182

(22) PCT Filed: Mar. 11, 2020
(86) PCT No.: PCT/US2020/022138

§ 371 Date: Sep. 10, 2021

Related U.S. Application Data
(60) Provisional application No. 62/817,179, filed on Mar. 12, 2019.

(51) Int. Cl. C09D 7/62; C09C 1/30; C09C 3/10; C09C 3/12; C09C 3/00; C09D 7/40

(52) U.S. Cl. CPC C09D 7/62; C08K 9/06; C09C 1/3081; C09C 3/10; C09C 3/12; C09C 3/006; C09D 7/70; C09D 7/68; C09D 7/69; C01P 2004/20; C01P 2004/32; C01P 2004/62; C01P 2004/61; C01P 2006/16; C09C 1/3072

(57) ABSTRACT

Disclosed in certain embodiments is a liquid coating composition comprising a liquid medium and a structural colorant comprising photonic particles comprising a metal oxide, the photonic particles having silane functional groups on at least a portion of the external surface of the photonic particles.

### CROSS-REFERENCE TO RELATED APPLICATION(S)

This application claims the benefit of priority of U.S. Provisional Patent Application No. 62/817,179, filed on Mar. 12, 2019, the disclosure of which is hereby incorporated by reference herein in its entirety.

### TECHNICAL FIELD

Disclosed are photonic structures having silane functional groups on at least a portion of their external surface, methods of their preparation and uses thereof.

### BACKGROUND

Traditional pigments and dyes exhibit color via light absorption and reflection, relying on chemical structure. Structural colorants exhibit color via light interference effects, relying on physical structure as opposed to chemical structure. Structural colorants are found in nature, for instance in bird feathers, butterfly wings and certain gemstones. Structural colorants are materials containing microscopically structured surfaces small enough to interfere with visible light and produce color.

Structural colorants can be manufactured to provide color in various goods such as paints and automotive coatings. For manufactured structural colorants, it is desired that the material exhibit high chromatic values, special photonic effects, dimensions allowing their use in particular applications, and chemical and thermal robustness. The robustness of the material is important in order to allow their in-process stability in paint systems and under various natural weathering conditions.

One concern in using structural colorants in liquid systems is the interference of the medium with the material. This interference can have an adverse effect on the robustness, stability and overall color characteristics of the final product.

There exists a need in the art for a structural colorant that can prevent or minimize the interference of a liquid medium with the material.

### OBJECTS AND SUMMARY OF THE INVENTION

It is an object of certain embodiments of the present invention to provide a structural colorant that minimizes or prevents the infiltration of a liquid medium therein.

It is another object of certain embodiments of the present invention to provide a method of preparing a structural colorant that minimizes or prevents the infiltration of a liquid medium therein.

It is a further object of certain embodiments of the present invention to provide a colorant system comprising a structural colorant that minimizes or prevents the infiltration of a liquid medium therein.

It is a further object of certain embodiments of the present invention to provide a manufactured article that has a colorant derived from a colorant system as disclosed herein.

One or more of the above objects and others can be achieved by virtue of the present invention which in certain embodiments is directed to a liquid coating composition comprising a liquid medium and structural colorants, the structural colorants comprising photonic particles comprising metal oxide particles and silane functional groups on at least a portion of the external surface of the metal oxide particles.

In certain embodiments, the present invention is directed to structural colorants comprising photonic particles comprising metal oxide particles and silane functional groups on at least a portion of the external surface of the metal oxide particles.

In certain embodiments, the present invention is directed to methods of preparing structural colorants comprising reacting photonic particles comprising metal oxide particles with a silane coupling agent such that the resultant structural colorants have silane functional groups on at least a portion of the metal oxide particles.

In certain embodiments, a method of preparing a liquid coating composition comprises preparing a photonic structures comprising: forming a dispersion of polymer particles and a metal oxide in a liquid medium; evaporating the liquid medium to obtain polymer-metal oxide particles; calcining the particles to obtain the photonic structures and reacting the structures with a silane coupling agent to obtain modified photonic structures. In some embodiments, the method further comprises combining the photonic structures with a liquid coating medium.

In some embodiments, the method further comprises evaporating the liquid medium in the presence of self-assembly substrates. In some embodiments, the reacting is performed by mixing the porous metal oxide particles with the silane coupling agent. In some embodiments, the mixing is dry mixing or wet mixing. In some embodiments, the mixing comprises preparing a solution of the silane coupling agent and adding the solution to a slurry of the photonic structures. In some embodiments, the solution comprises an aqueous solvent, an organic solvent or a combination thereof. In some embodiments, the slurry is an aqueous slurry.

In some embodiments, the silane coupling agent is prehydrolyzed. In some embodiments, the silane coupling agent is hydrolyzed during mixing. In some embodiments, the photonic structures are recovered by filtration or centrifugation. In some embodiments, the photonic structures are recovered by filtration. In some embodiments, the photonic structures are recovered by centrifugation. In some embodiments, the drying comprises microwave irradiation, oven drying, drying under vacuum, drying in the presence of a desiccant, or a combination thereof. In some embodiments, the droplets are formed in a microfluidic device.

In some embodiments, a wt/wt ratio of polymer particles to the metal oxide is from about 0.5/1 to about 10.0/1. In some embodiments, the polymer particles have an average diameter of from about 50 nm to about 990 nm. In some embodiments, the polymer is selected from the group consisting of poly(meth)acrylic acid, poly(meth)acrylates, polystyrenes, polyacrylamides, polyethylene, polypropylene, polylactic acid, polyacrylonitrile, derivatives thereof, salts thereof, copolymers thereof and combinations thereof.

In some embodiments, the metal oxide is selected from the group consisting of silica, titania, alumina, zirconia, ceria, iron oxides, zinc oxide, indium oxide, tin oxide, chromium oxide and combinations thereof.

In some embodiments, removing the polymer particles from the template particles comprises calcination, pyrolysis or solvent removal. In some embodiments, removing the polymer particles comprises calcining the template microspheres at temperatures of from about 300° C. to about 800° C. for a period of from about 1 hour to about 8 hours.

The structural colorants according to any of the above embodiments can be, e.g., selected from the group consisting of photonic spheres, photonic crystals, photonic granules, opals, inverse opals, folded photonic structures and platelet-like photonic structures.

### BRIEF DESCRIPTION OF THE DRAWINGS

The disclosure described herein is illustrated by way of example and not by way of limitation in the accompanying figures.

FIG. 1 depicts silica direct photonic balls formed using 250 nm silica colloids.

FIG. 2 depicts the effect of surface functionalization of an inverse opal film on the infiltration of a clear coat resin into the pores.

FIG. 3 depicts free-form silica platelet-like structures surface modified with 13F after the draw-down using a solvent-based clearcoat.

### DETAILED DESCRIPTION

In certain embodiments, the present invention is directed to structural colorants comprising photonic particles comprising metal oxide particles and silane functional groups on at least a portion of the external surface of the metal oxide particles. Other embodiments are directed to liquid compositions comprising a liquid medium and the structural colorants disclosed herein; methods of preparing the structural colorants disclosed herein; coatings comprising the structural colorants disclosed herein and articles of manufacture comprising a colorant comprising the structural colorants disclosed herein.

In the above embodiments, the structural colorants are selected from the group consisting of photonic spheres, photonic crystals, photonic granules, opals, inverse opals, folded photonic structures and platelet-like photonic structures.

In certain embodiments, the structural colorants exhibit angle-dependent color or angle independent color.

In certain embodiments the silane functional groups are epoxy silanes, amino silanes, alkyl silanes, alkylhalosilanes or a combination thereof.

In certain embodiments the silyl functional groups are derived from reacting the porous metal oxide microspheres with a silane coupling agent.

In certain embodiments, the silane coupling agent comprises an organo functional group and a hydrolysable functional group bonded directly or indirectly to silicone.

In certain embodiments, the hydrolysable functional group is an alkoxy group.

In certain embodiments, the structural colorants can be combined with one or more of a liquid medium, organic binders, additives, organic pigments, inorganic pigments or a combination thereof.

In certain embodiments, the silyl functional groups are aminoethyl trimethoxy silanes, aminopropyl trimethoxysilanes, glycidoxypropyl trimethoxy silanes or a combination thereof. Certain embodiments can further comprise an acrylic functional resin.

In certain embodiments, the alkylhalosilane is an alkylchlorosilane. In other embodiments, the silane functional groups are decyltrichlorosilanes, perfluorooctyltrichlorosilanes or a combination thereof.

In certain embodiments, the metal oxide is selected from the group consisting of silica, titania, alumina, zirconia, ceria, iron oxides, zinc oxide, indium oxide, tin oxide, chromium oxide and combinations thereof.

In other embodiments, the silyl functional groups prevent or substantially prevent the infiltration of the liquid medium into pores of the structural colorants.

In certain embodiments, the reflective spectra after storage for 24 hours at room temperature, standard atmosphere and relative humidity has a wavelength within 10% of the liquid coating composition prior to storage.

In certain embodiments, the reflective spectra after storage for 2 days, 5 days, 7 days, 14 days or 28 days at room temperature, standard atmosphere and relative humidity has a wavelength within 8%, 5%, 4% or 2% of the liquid coating composition prior to storage.

Certain embodiments exhibit a wavelength range selected from the group consisting of 380 to 450 nm, 451 to 495 nm, 496 to 570 nm, 571 to 590 nm, 591 to 620 nm and 621 to 750 nm.

In certain embodiments with a liquid medium, the liquid medium can be, e.g., an aqueous medium, an organic medium or a combination thereof.

In certain embodiments, the structural colorant particles (e.g., spherical or platelet-like) can have, e.g., one or more of an average diameter of from about 0.5 μm to about 100 μm, an average porosity of from about 0.10 to about 0.80 and an average pore diameter of from about 50 nm to about 999 nm. In alternative embodiments, the particles can have, e.g., one or more of an average diameter of from about 1 μm to about 75 μm, an average porosity of from about 0.45 to about 0.65 and an average pore diameter of from about 50 nm to about 800 nm.

In certain embodiments, the structural colorants particle have an average diameter, e.g., of from about 1 μm to about 75 μm, from about 2 μm to about 70 μm, from about 3 μm to about 65 μm, from about 4 μm to about 60 μm, from about 5 μm to about 55 μm or from about 5 μm to about 50 μm; for example from any of about 5 μm, about 6 μm, about 7 μm, about 8 μm, about 9 μm, about 10 μm, about 11 μm, about 12 μm, about 13 μm, about 14 μm or about 15 μm to any of about 16 μm, about 17 μm, about 18 μm, about 19 μm, about 20 μm, about 21 μm, about 22 μm, about 23 μm, about 24 μm or about 25 μm. Alternative embodiments can have an average diameter of from any of about 4.5 μm, about 4.8 μm, about 5.1 μm, about 5.4 μm, about 5.7 μm, about 6.0 μm, about 6.3 μm, about 6.6 μm, about 6.9 μm, about 7.2 μm or about 7.5 μm to any of about 7.8 μm about 8.1 μm, about 8.4 μm, about 8.7 μm, about 9.0 μm, about 9.3 μm, about 9.6 μm or about 9.9 μm.

In other embodiments, the structural colorant particles have an average porosity, e.g., of from any of about 0.10, about 0.12, about 0.14, about 0.16, about 0.18, about 0.20, about 0.22, about 0.24, about 0.26, about 0.28, about 0.30, about 0.32, about 0.34, about 0.36, about 0.38, about 0.40, about 0.42, about 0.44, about 0.46, about 0.48 about 0.50, about 0.52, about 0.54, about 0.56, about 0.58 or about 0.60 to any of about 0.62, about 0.64, about 0.66, about 0.68, about 0.70, about 0.72, about 0.74, about 0.76, about 0.78, about 0.80 or about 0.90. Alternative embodiments can have an average porosity of from any of about 0.45, about 0.47, about 0.49, about 0.51, about 0.53, about 0.55 or about 0.57 to any of about 0.59, about 0.61, about 0.63 or about 0.65.

In further embodiments, the structural colorant particles have an average pore diameter, e.g., of from any of about 50 nm, about 60 nm, about 70 nm, 80 nm, about 100 nm, about 120 nm, about 140 nm, about 160 nm, about 180 nm, about 200 nm, about 220 nm, about 240 nm, about 260 nm, about 280 nm, about 300 nm, about 320 nm, about 340 nm, about 360 nm, about 380 nm, about 400 nm, about 420 nm or about 440 nm to any of about 460 nm, about 480 nm, about 500 nm, about 520 nm, about 540 nm, about 560 nm, about 580 nm, about 600 nm, about 620 nm, about 640 nm, about 660 nm, about 680 nm, about 700 nm, about 720 nm, about 740 nm, about 760 nm, about 780 nm or about 800 nm. Alternative embodiments can have an average pore diameter of from any of about 220 nm, about 225 nm, about 230 nm, about 235 nm, about 240 nm, about 245 nm or about 250 nm to any of about 255 nm, about 260 nm, about 265 nm, about 270 nm, about 275 nm, about 280 nm, about 285 nm, about 290 nm, about 295 nm or about 300 nm.

In further embodiments, the structural colorant particles can have, e.g., an average diameter of from any of about 4.5 μm, about 4.8 μm, about 5.1 μm, about 5.4 μm, about 5.7 μm, about 6.0 μm, about 6.3 μm, about 6.6 μm, about 6.9 μm, about 7.2 μm or about 7.5 μm to any of about 7.8 μm about 8.1 μm, about 8.4 μm, about 8.7 μm, about 9.0 μm, about 9.3 μm, about 9.6 μm or about 9.9 μm; an average porosity of from any of about 0.45, about 0.47, about 0.49, about 0.51, about 0.53, about 0.55 or about 0.57 to any of about 0.59, about 0.61, about 0.63 or about 0.65; and an average pore diameter of from any of about 220 nm, about 225 nm, about 230 nm, about 235 nm, about 240 nm, about 245 nm or about 250 nm to any of about 255 nm, about 260 nm, about 265 nm, about 270 nm, about 275 nm, about 280 nm, about 285 nm, about 290 nm, about 295 nm or about 300 nm.

In further embodiments, the structural colorants can have, e.g., from about 60.0 wt % to about 99.9 wt % metal oxide, based on the total weight of the colorants. In other embodiments, the structural colorants comprise from about 0.1 wt % to about 40.0 wt % of one or more light absorbers, based on the total weight of the colorants. In other embodiments, the metal oxide is from any of about 60.0 wt %, about 64.0 wt %, about 67.0 wt %, about 70.0 wt %, about 73.0 wt %, about 76.0 wt %, about 79.0 wt %, about 82.0 wt % or about 85.0 wt % to any of about 88.0 wt %, about 91.0 wt %, about 94.0 wt %, about 97.0 wt %, about 98.0 wt %, about 99.0 wt % or about 99.9 wt % metal oxide, based on the total weight of the structural colorants.

In certain embodiments, the present invention is directed to methods of preparing structural colorants comprising reacting photonic particles comprising a metal oxide particles with a silane coupling agent such that the resultant structural colorants have silane functional groups on at least a portion of the external surface of the metal oxide particles.

In certain embodiments, the structural colorants prior to reaction with a silane coupling agent are prepared by a process comprising forming a liquid dispersion of polymer particles and a metal oxide; optionally forming liquid droplets of the dispersion; drying the liquid droplets or dispersion to provide polymer template particles comprising polymer and metal oxide; removing the polymer from the template spheres to provide metal oxide particles, and reacting the metal oxide spheres with the silane coupling agent. The resultant material is then optionally combined with a liquid medium. In such embodiments, the particles may be spherical or platelet-like and/or porous and/or monodisperse.

In other embodiments, the structural colorants prior to reaction with a silane coupling agent are prepared by a process comprising forming a liquid dispersion of monodisperse polymer particles; forming at least one further liquid solution or dispersion of monodisperse polymer nanoparticles; mixing each of the solutions or dispersions together; optionally forming droplets of the mixture; and drying the droplets or dispersion to provide polymer particles that are polydisperse when the average diameters of the monodisperse polymer particles of each of the dispersions are different. In certain such embodiments, the particles are spherical or platelet-like and/or porous.

In certain embodiments, the structural colorants prior to reaction with a silane coupling agent are prepared by a process comprising forming a dispersion of polymer particles and a metal oxide in a liquid medium; evaporating the liquid medium to obtain polymer-metal oxide particles; and calcining the particles to obtain the structural colorants. The resultant material is then optionally combined with a liquid medium. In these embodiments, the evaporation of the liquid medium may be performed in the presence of self-assembly substrates such as conical tubes or photolithography slides. In certain such embodiments, the particles are spherical or platelet-like structures and/or porous.

In certain embodiments, the reacting is performed by mixing the structural colorants with the silane coupling agent. The mixing can be, e.g., dry mixing or wet mixing. The mixing can also comprise, e.g., preparing a solution of the silane coupling agent and adding the solution to a slurry of the structural colorants. The solution can comprise, e.g., an aqueous solvent, an organic solvent or a combination thereof. The slurry can be, e.g., an aqueous slurry, an organic slurry or a combination thereof.

In certain embodiments, the silane coupling agent is prehydrolyzed. In other embodiments, the silane coupling agent is hydrolyzed during mixing.

In certain embodiments, the structural colorants may be recovered, e.g., by filtration or centrifugation.

In certain embodiments, the drying comprises microwave irradiation, oven drying, drying under vacuum, drying in the presence of a desiccant, or a combination thereof.

In certain embodiments with liquid droplets, the droplets are formed with a microfluidic device. The microfluidic device can contain a droplet junction having a channel width, e.g., of from any of about 10 μm, about 15 μm, about 20 μm, about 25 μm, about 30 μm, about 35 μm, about 40 μm or about 45 μm to any of about 50 μm, about 55 μm, about 60 μm, about 65 μm, about 70 μm, about 75 μm, about 80 μm, about 85 μm, about 90 μm, about 95 μm or about 100 μm.

In certain embodiments, the wt/wt ratio of polymer particles to the metal oxide is from about 0.5/1 to about 10.0/1. In other embodiments, the wt/wt ratio is from any of about 0.1/1, about 0.5/1, about 1.0/1, about 1.5/1, about 2.0/1, about 2.5/1 or about 3.0/1 to any of about 3.5/1, about 4.0/1, about 5.0/1, about 5.5/1, about 6.0/1, about 6.5/1, about 7.0/1, about 8.0/1, about 9.0/1 or about 10.0/1.

In certain embodiments, the polymer particles have an average diameter of from about 50 nm to about 990 nm. In other embodiments, the particles have an average diameter of from any of about 50 nm, about 75 nm, about 100 nm, about 130 nm, about 160 nm, about 190 nm, about 210 nm, about 240 nm, about 270 nm, about 300 nm, about 330 nm, about 360 nm, about 390 nm, about 410 nm, about 440 nm, about 470 nm, about 500 nm, about 530 nm, about 560 nm, about 590 nm or about 620 nm to any of about 650 nm, a bout 680 nm, about 710 nm, about 740 nm, about 770 nm, about 800 nm, about 830 nm, about 860 nm, about 890 nm, about 910 nm, about 940 nm, about 970 nm or about 990 nm.

In certain embodiments, the polymer is selected from the group consisting of poly(meth)acrylic acid, poly(meth)acrylates, polystyrenes, polyacrylamides, polyethylene, polypropylene, polylactic acid, polyacrylonitrile, derivatives thereof, salts thereof, copolymers thereof and combinations thereof. The polystyrenes can be, e.g., polystyrene copolymers such as polystyrene/acrylic acid, polystyrene/poly(ethylene glycol) methacrylate or polystyrene/styrene sulfonate.

In certain embodiments, the metal oxide is selected from the group consisting of silica, titania, alumina, zirconia, ceria, iron oxides, zinc oxide, indium oxide, tin oxide, chromium oxide and combinations thereof.

In certain embodiments, removing the polymer spheres from the template microspheres comprises calcination, pyrolysis or solvent removal. The calcining of the template spheres can be, e.g., at temperatures of from about 300° C. to about 800° C. for a period of from about 1 hour to about 8 hours.

In certain embodiments disclosed herein, prior to incorporation with the silane coupling agent, the structural colorants can be metal oxide particles (e.g., photonic balls or platelet-like) which may be prepared with the use of a polymeric sacrificial template. In one embodiment, an aqueous colloid dispersion containing polymer particles and a metal oxide is prepared, the polymer particles being, e.g., nano-scaled. The aqueous colloidal dispersion is mixed with a continuous oil phase, for instance within a microfluidic device, to produce a water-in-oil emulsion. Emulsion aqueous droplets are prepared, collected and dried to form particles (e.g., spheres) containing polymer particles (e.g., nanoparticles) and metal oxide. Alternatively, the particles can be prepared by evaporation. The polymer particles or spheres are then removed, for instance via calcination, to provide metal oxide particles or spheres that are, e.g., micron-scaled, and that contain a high degree of porosity with, e.g., nano-scaled pores. The particles may contain uniform pore diameters as a result of the polymer particles being spherical and monodisperse. The removal of the polymer particles form an “inverse structure” or inverse opal. The particles prior to calcination are considered to be a “direct structure” or direct opal. The above methodology can also be modified to provide crystals, granules or folded structures.

The metal oxide microspheres in certain embodiments are porous and can be advantageously sintered, resulting in a continuous solid structure which is thermally and mechanically stable.

In some embodiments, droplet formation and collection occurs within a microfluidic device. Microfluidic devices are for instance narrow channel devices having a micron-scaled droplet junction adapted to produce uniform size droplets connected to a collection reservoir. Microfluidic devices for example contain a droplet junction having a channel width of from about 10 μm to about 100 μm. The devices are for instance made of polydimethylsiloxane (PDMS) and may be prepared for example via soft lithography. An emulsion may be prepared within the device via pumping an aqueous dispersed phase and oil continuous phase at specified rates to the device where mixing occurs to provide emulsion droplets. Alternatively, an oil-in-water emulsion may be employed.

Suitable template polymers include thermoplastic polymers. For example, template polymers are selected from the group consisting of poly(meth)acrylic acid, poly(meth)acrylates, polystyrenes, polyacrylamides, polyvinyl alcohol, polyvinyl acetate, polyesters, polyurethanes, polyethylene, polypropylene, polylactic acid, polyacrylonitrile, polyvinyl ethers, derivatives thereof, salts thereof, copolymers thereof and combinations thereof. For example, the polymer is selected from the group consisting of polymethyl methacrylate, polyethyl methacrylate, poly(n-butyl methacrylate), polystyrene, poly(chloro-styrene), poly(alpha-methylstyrene), poly(N-methylolacrylamide), styrene/methyl methacrylate copolymer, polyalkylated acrylate, polyhydroxyl acrylate, polyamino acrylate, polycyanoacrylate, polyfluorinated acrylate, poly(N-methylolacrylamide), polyacrylic acid, polymethacrylic acid, methyl methacrylate/ethyl acrylate/acrylic acid copolymer, styrene/methyl methacrylate/acrylic acid copolymer, polyvinyl acetate, polyvinylpyrrolidone, polyvinylcaprolactone, polyvinylcaprolactam, derivatives thereof, salts thereof, and combinations thereof.

In certain embodiments, polymer templates include polystyrenes, including polystyrene and polystyrene copolymers. Polystyrene copolymers include copolymers with water-soluble monomers, for example polystyrene/acrylic acid, polystyrene/poly(ethylene glycol) methacrylate, and polystyrene/styrene sulfonate.

Present metal oxides include oxides of transition metals, metalloids and rare earths, for example silica, titania, alumina, zirconia, ceria, iron oxides, zinc oxide, indium oxide, tin oxide, chromium oxide, mixed metal oxides, combinations thereof, and the like.

The wt/wt (weight/weight) ratio of polymer nanoparticles to metal oxide is for instance from about 0.1/1 to about 10.0/1 or from about 0.5/1 to about 10.0/1.

The continuous oil phase comprises for example an organic solvent, a silicone oil or a fluorinated oil. According to the invention “oil” means an organic phase immiscible with water. Organic solvents include hydrocarbons, for example, heptane, hexane, toluene, xylene, and the like, as well as alkanols such as methanol, ethanol, propanol, etc.

The emulsion droplets are collected, dried and the polymer is removed. Drying is performed for instance via microwave irradiation, in a thermal oven, under vacuum, in the presence of a desiccant or a combination thereof.

Polymer removal may be performed for example via calcination, pyrolysis or with a solvent (solvent removal). Calcination is performed in some embodiments at temperatures of at least about 200° C., at least about 500° C., at least about 1000° C., from about 200° C. to about 1200° C. or from about 200° C. to about 700° C. The calcining can be for a suitable period, e.g., from about 0.1 hour to about 12 hours or from about 1 hour to about 8.0 hours. In other embodiments, the calcining can be for at least about 0.1 hour, at least about 1 hour, at least about 5 hours or at least about 10 hours. In other embodiments, the calcining can be from any of about 200° C., about 350° C., about 400° C., 450° C., about 500° C. or about 550° C. to any of about 600° C., about 650° C., about 700° C. or about 1200° C. for a period of from any of about 0.1 h (hour), 1 h, about 1.5 h, about 2.0 h, about 2.5 h, about 3.0 h, about 3.5 h or about 4.0 h to any of about 4.5 h, about 5.0 h, about 5.5 h, about 6.0 h, about 6.5 h, about 7.0 h, about 7.5 h about 8.0 h or about 12 h.

Alternatively, a liquid dispersion comprising polymer particles and metal oxide is formed with an oil dispersed phase and a continuous water phase to form an oil-in-water emulsion. The oil droplets may be collected and dried as are aqueous droplets.

The particles may be spherical or spherical-like and may be micron-scaled, for example having average diameters from about 0.5 microns (μm) to about 100 μm. The polymer particles employed as a template may also be spherical and nano-scaled and are monodisperse, having average diameters for instance from about 50 nm to about 999 nm. The polymer particles may also be polydisperse by being a mixture of monodisperse particles. The metal oxide employed may also be in particle form, which particles may be nano-scaled.

The metal oxide of the dispersion may be provided as metal oxide or may be provided from a metal oxide precursor, for instance via a sol-gel technique.

Drying of the polymer/metal oxide particles followed by removal of the polymer provides particles having uniform voids (pores). In general, in the present processes, each droplet provides a single particle. The pore diameters are dependent on the size of the polymer particles. Some compaction may occur upon polymer removal, providing pore sizes somewhat smaller than the original polymer particle size, for example from about 10% to about 40% smaller than the polymer particle size. The pore diameters are uniform as are the polymer particle shape and size.

Pore diameters may range in some embodiments from about 50 nm to about 999 nm prior to mixing with the silane coupling agent.

The average porosity of the present metal oxide particles prior to mixing with the silane coupling agent may be relatively high, for example from about 0.10 or about 0.30 to about 0.80 or about 0.90. Average porosity of a particle means the total pore volume, as a fraction of the volume of the entire particle. Average porosity may be called “volume fraction.”

In some embodiments, a porous particle may have a solid core (center) where the porosity is in general towards the exterior surface of the particle (e.g., sphere). In other embodiments, a porous particle may have a hollow core where a major portion of the porosity is towards the interior of the particle (e.g., sphere). In other embodiments, the porosity may be distributed throughout the volume of the particle. In other embodiments, the porosity may exist as a gradient, with higher porosity towards the exterior surface of the particle and lower or no porosity (solid) towards the center; or with lower porosity towards the exterior surface and with higher or complete porosity (hollow) towards the center.

For any porous spherical particle, the average sphere diameter is larger than the average pore diameter, for example, the average sphere diameter is at least about 25 times, at least about 30 times, at least about 35 times, or at least about 40 times larger than the average pore diameter.

In some embodiments, the ratio of average sphere diameter to average pore diameter prior to mixing with the silane coupling agent is for instance from any of about 40/1, about 50/1, about 60/1, about 70/1, about 80/1, about 90/1, about 100/1, about 110/1, about 120/1, about 130/1, about 140/1, about 150/1, about 160/1, about 170/1, about 180/1 or about 190/1 to any of about 200/1, about 210/1, about 220/1, about 230/1, about 240/1, about 250/1, about 260/1, about 270/1, about 280/1, about 290/1, about 300/1, about 310/1, about 320/1, about 330/1, about 340/1 or about 350/1.

Polymer template particles comprising monodisperse polymer particles may provide, when the polymer is removed, metal oxide microspheres having pores that in general have similar pore diameters. In other embodiments, polydisperse polymer particles can be used wherein the average diameters of the particles are different.

Also disclosed are polymer particles comprising more than one population of monodisperse polymer particles, wherein each population of monodisperse polymer particles has different average diameters.

The particles prior to mixing with the silane coupling agent comprise mainly metal oxide, that is, they may consist essentially of or consist of metal oxide. Advantageously, a bulk sample of the particles exhibits color observable by the human eye. A light absorber may also be present in the particles, which may provide a more saturated observable color. Absorbers include inorganic and organic pigments, for example a broadband absorber such as carbon black. Absorbers may for instance be added by physically mixing the particles and the absorbers together or by including the absorbers in the droplets to be dried. For carbon black, controlled calcination may be employed to produce carbon black in situ from polymer decomposition. A present particle may exhibit no observable color without added light absorber and exhibit observable color with added light absorber. Preferably, the photonic particle characteristics are maintained or substantially maintained after mixing with the silane coupling agent.

The structural colorants with silane moieties of the present invention may be employed as colorants for example for aqueous formulations, oil-based formulations, inks, coatings formulations, foods, plastics, cosmetics formulations or materials or for medical applications. Coatings formulations include for instance architectural coatings, automotive coatings or varnishes.

The structural colorants with silane moieties of the present invention may exhibit angle-dependent color or angle-independent color. “Angle-dependent” color means that observed color has dependence on the angle of incident light on a sample or on the angle between the observer and the sample. “Angle-independent” color means that observed color has substantially no dependence on the angle of incident light on a sample or on the angle between the observer and the sample.

Angle-dependent color may be achieved for example with the use of monodisperse polymer spheres. Angle-dependent color may also be achieved when a step of drying the liquid droplets to provide polymer template spheres is performed slowly, allowing the polymer spheres to become ordered. Angle-independent color may be achieved when a step of drying the liquid droplets is performed quickly, not allowing the polymer spheres to become ordered.

In certain embodiments, the structural colorants may comprise from about 60.0 wt % (weight percent) to about 99.9 wt % metal oxide and from about 0.1 wt % to about 40.0 wt % of one or more light absorbers, based on the total weight of the particles. In other embodiments, the light absorber can be, e.g., from about 0.1 wt % to about 40.0 wt % of one or more light absorbers, for example comprising from any of about 0.1 wt %, about 0.3 wt %, about 0.5 wt %, about 0.7 wt %, about 0.9 wt %, about 1.0 wt %, about 1.5 wt %, about 2.0 wt %, about 2.5 wt %, about 5.0 wt %, about 7.5 wt %, about 10.0 wt %, about 13.0 wt %, about 17.0 wt %, about 20.0 wt % or about 22.0 wt % to any of about 24.0 wt %, about 27.0 wt %, about 29.0 wt %, about 31.0 wt %, about 33.0 wt %, about 35.0 wt %, about 37.0 wt %, about 39.0 wt % or about 40.0 wt % of one or more light absorbers, based on the total weight of the particles.

According to the invention, particle size is synonymous with particle diameter and is determined for instance by scanning electron microscopy (SEM) or transmission electron microscopy (TEM). Average particle size is synonymous with D50, meaning half of the population resides above this point, and half below. Particle size refers to primary particles. Particle size may be measured by laser light scattering techniques, with dispersions or dry powders.

Mercury porosimetry analysis can be used to characterize the porosity of the particles. Mercury porosimetry applies controlled pressure to a sample immersed in mercury. External pressure is applied for the mercury to penetrate into the voids/pores of the material. The amount of pressure required to intrude into the voids/pores is inversely proportional to the size of the voids/pores. The mercury porosimeter generates volume and pore size distributions from the pressure versus intrusion data generated by the instrument using the Washburn equation. For example, porous silica particles containing voids/pores with an average size of 165 nm have an average porosity of 0.8.

The term “bulk sample” means a population of particles. For example, a bulk sample of particles is simply a bulk population of particles, for instance ≥0.1 mg, ≥0.2 mg, ≥0.3 mg, ≥0.4 mg, ≥0.5 mg, ≥0.7 mg, ≥1.0 mg, ≥2.5 mg, ≥5.0 mg, ≥10.0 mg or ≥25.0 mg. A bulk sample of particles may be substantially free of other components.

The phrase “exhibits color observable by the human eye” means color will be observed by an average person. This may be for any bulk sample distributed over any surface area, for instance a bulk sample distributed over a surface area of from any of about 1 cm², about 2 cm², about 3 cm², about 4 cm², about 5 cm² or about 6 cm² to any of about 7 cm², about 8 cm², about 9 cm², about 10 cm², about 11 cm², about 12 cm², about 13 cm², about 14 cm² or about 15 cm². It may also mean observable by a CIE 1931 2° standard observer and/or by a CIE 1964 100 standard observer. The background for color observation may be any background, for instance a white background, black background or a dark background anywhere between white and black.

The term “of” may mean “comprising”, for instance “a liquid dispersion of” may be interpreted as “a liquid dispersion comprising”.

The terms “microspheres”, “nanospheres”, “droplets”, etc., referred to herein may mean for example a plurality thereof, a collection thereof, a population thereof, a sample thereof or a bulk sample thereof.

The term “micro” or “micro-scaled” means from about 0.5 μm to about 999 μm. The term “nano” or “nano-scaled” means from about 1 nm to about 999 nm.

The term “monodisperse” in reference to a population of particles means particles having generally uniform shapes and generally uniform diameters. A present monodisperse population of particles for instance may have 90%, 91%, 92%, 93%, 94%, 95%, 96%, 97%, 98% or 99% of the particles by number having diameters within ±7%, ±6%, ±5%, ±4%, ±3%, 2% or ±1% of the average diameter of the population.

Removal of a monodisperse population of polymer particles provides porous metal oxide particles having a corresponding population of pores having an average pore diameter.

The term “substantially free of other components” means for example containing ≤5%, 4%, 3%, ≤2%, ≤1% or ≤0.5% by weight of other components.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±5%, ±4%, ±3%, +2%, +1%, +0.5%, +0.4%, +0.3%, +0.2%, ±0.1% or ±0.05%. All numeric values are modified by the term “about” whether or not explicitly indicated. Numeric values modified by the term “about” include the specific identified value. For example “about 5.0” includes 5.0.

U.S. patents, U.S. patent applications and published U.S. patent applicants discussed herein are hereby incorporated by reference.

Unless otherwise indicated, all parts and percentages are by weight. Weight percent (wt %), if not otherwise indicated, is based on an entire composition free of any volatiles, that is, based on dry solids content.

In certain embodiments, the photonic material disclosed herein can have UV absorption functionality and can be coated on or incorporated into a substrate, e.g., plastics, wood, fibers or fabrics, ceramics, glass, metals and composite products thereof.

### Illustrative Examples

The following examples are set forth to assist in understanding the disclosed embodiments and should not be construed as specifically limiting the embodiments described and claimed herein. Such variations of the embodiments, including the substitution of all equivalents now known or later developed, which would be within the purview of those skilled in the art, and changes in formulation or minor changes in experimental design, are to be considered to fall within the scope of the embodiments incorporated herein.

### Example 1: Synthesis of PEG-Capped Polystyrene (PS) Colloids

The materials in this example include: styrene (99%, Sigma-Aldrich Reagent Plus, with 4-ter-butylcatechol as stabilizer); 4-methoxyphenol (BISOMER S 20 W, GEO Speciality Chemicals); acrylic acid (Sigma-Aldrich); and ammonium persulfate (APS, OmniPur, Calbiochem).

A 500 ml three-neck round-bottom flask equipped with a water condenser, thermometer, nitrogen inlet, and magnetic stirrer was placed in an oil bath. 129 ml of deionized water (18.2 Macm) was added and purged with nitrogen through a needle inserted into the reaction mixture while stirring at 300 rpm for 15 minutes. Styrene (8.84 g, 84.8 mmol) was added under stirring and the flask was heated to 80° C. The needle delivering nitrogen was withdrawn from the reaction mixture yet left inside the flask to allow nitrogen flow through the flask for the duration of the reaction. Once the bath equilibrated at 80° C., BISOMER S 30W (895.5 mg, 7.2 mmol) was added and the mixture was stirred for 5 minutes. APS (34.0 mg, 0.1 mmol) dissolved in deionized water (1 ml) was then added to the reaction mixture over 10 seconds. The reaction was stirred for 18 hours at 80° C., yielding a white, opaque, colloid solution. Following the completion of the reaction the colloids were filtered through a Kimwipe resting on a glass funnel and introduced into a dialysis bag (Spectra/Por 12-14 kD). The dialysis bag was placed in a 1 gallon deionized water bath for 72 hours. Water was changed approximately every 24 hours. After 72 hours the purified dispersion of the colloids was transferred into a glass bottle. The size and size distribution of the colloids (244±5 nm) was measured using SEM.

### Example 2: Synthesis of Carboxylate-Capped PS Colloids

An analogous procedure to the described above with the following modifications was used for the synthesis of carboxylate capped colloids: 1 L three-neck flask, 480 ml of DI water, 48 g of styrene, 200 mg of acrylic acid (instead of BISOMER), 200 mg of APS. The procedure resulted in 320 nm colloids.

### Example 3: Synthesis of Polymethylmethacrylate (PMMA) Colloids

The materials in this example include: ammonium persulfate (APS)—free-radical initiator; methyl methacrylate (MMA)—monomer; ethylene glycol dimethacrylate (EGDMA)-crosslinker; 1-dodecanethiol—chain-transfer agent.

Using the same set-up as shown in (1), 200 mg of APS were added to 90 ml DI water and left to stir for at least one hour. The temperature was monitored closely to maintain a steady 90° C. throughout the reaction. In a separate vessel 10.5 ml of MMA, 189.6 μL of EGDMA, and 47.3 μL of dodecanethiol were mixed and sonicated for 5 minutes and then quickly added into the flask. The temperature of the reaction was monitored, making sure that it recovered to 90° C. The solution was stirred for 3-6 hours before being removed from heat and cooled. The product was filtered through a kimwipe into dialysis tubing and purified over 10 cycles, changing the water once a day.

This procedure resulted in 100 ml total volume of monodisperse poly(methyl methacrylate) (PMMA) colloid about 280 nm in size. Adjustments to concentrations of reactants and reaction temperature were also investigated. Temperature was found to be the most effective factor controlling the colloid size; typically 95° C. produced sizes of about 240 nm, 85° C. produced sizes of about 300 nm, 80° C. produced sizes of about 350 nm.

### Example 4: Free-Form Platelet-Like Structures (Off of the Side Walls of the Vial)

The co-assembly solution is comprised of a mixture of a silica precursor solution and polymer colloids (PMMA or PS) suspended in water. The silica precursor was prepared by combining tetraethylorthrosylicate (TEOS), ethanol, and 0.01 M HCl (1:1.5:1, v/v) and left to stir for 1 hour. 100 pl of the precursor solution was added to 20 ml water containing 0.1% colloids (w/v). Solutions were briefly sonicated (15 seconds) and then placed undisturbed in a 65° C. oven for 2-3 days, or until the liquid fully evaporated. Calcination was performed by ramping the temperature to at 500° C. for 5 hours, isothermal step for two hours, and ramp down for 4 hours. Typical yields were about 4 to 5 mg per 20 ml. Alterations in calcination conditions (temperature, ramping speeds, and oxygen-free environments) were also investigated.

### Example 5: Templated Platelet-Like Structures

Prior to photolithography microscope slides were cleaned with acid piranha (1:3 sulfuric acid: 30% hydrogen peroxide) for a minimum of 30 minutes, followed by oxygen plasma activation for 5 minutes and then dehydration at 180° C. for at least 15 min. SU-8 2015 photoresist (Microchem) was spun onto the slides and flood exposed to UV light (365 nm), to result in about 15 micron flat layer of sacrificial photoresist. After a post-exposure hardbake (95° C.), a secondary layer of SU8 2015 was deposited. After a soft (65° C.) and hard (95° C.) bake steps, slides were masked with Mylar masks (FineLine Imaging) and exposed to UV light (365 nm). After post-exposure soft and hard bake steps, slides were submerged in SU-8 developer (Microchem) until sufficiently developed. Typical development time for this thickness is about 3 min. The indication for complete development is the absence of white precipitate when the sample is rinsed with isopropanol. The procedure resulted in the formation of templates for platelet-like structure growth within channels 25 or 50 μm wide.

Prepared glass slides with SU-8 channels were cleaned via oxygen plasma for 5 min to lower the contact angle between the surface and the co-assembly solution. The samples were suspended vertically in 25 ml-slide boxes containing the co-assembly solution (described in part 4) in an oven (Memmert) at 65° C. Typical time for complete evaporation was 48 h. Slides were calcined using the same conditions mentioned above. This step served to sinter the matrix, remove the polymer colloids, and release the photonic bricks from the photoresist template. Typical yields of templated photonic bricks were 1-3 mg per slide. The presence of photoresist limited the alterations that could be made to calcination, for example in an oxygen free environment the resist did not fully combust and contaminated the final product.

### Example 6: “Bulk” Platelet-Like Structures

30 50-ml conical tubes, each containing 20 ml of polystyrene colloids (solid content as synthesized about 5 wt %), were allowed to completely dry in a 70° C. oven. The resulting “bulk” direct opals were collected and spread over an absorbent filter paper. The filter paper helps to reduce an over-layer of silica resulting from the excess of TEOS residing on the opals following infiltration. A solution of TEOS was prepared in the following manner: 1000 μl of TEOS were added to a mixture containing 800 μl of methanol and 460 μl of water followed by 130 μl of a concentrated hydrochloric acid and 260 mg of cobalt nitrate dissolved in 160 μl of water. The opals were infiltrated with this solution in three repetitive steps, allowing for one hour drying in between each infiltration, to ensure substantial filling of the structure. After the final infiltration the material (compound opal) was calcined under argon or in the presence of air, using the following conditions: 10 min ramp to 65° C., hold for 3 hours (to allow for drying and, in the case of argon, to ensure removal of all oxygen from the system), ramp for two hours up to 650° C., hold for two hours and ramp down to room temperature for two hours. After calcination the final product was ground through two consecutive metal sieves, with 140 and 90 microns pore sizes respectively using ethanol to help transfer the powder through the meshes.

### Example 7: Surface Modification of Platelet-Like Structures

Following particle size reduction and solvent evaporation platelet-like structures were left for one hour in a 130° C. oven. Then the platelet-like structures were transferred into a vacuum desiccator containing three two-ml vials with 100 pl of 1H,1H,2H,2H-tridecafiuorooctyltrichlorosilane (13F) each for 48 h. Upon completion, the powder was placed in an oven at 130° C. for 15 min.

Following particle size reduction, 13F-silane was added to the ethanol dispersion of platelet-like structures to result in 1% (v/v). The mixture was left to react for one hour. Following functionalization the platelet-like structures were rinsed thoroughly with ethanol and DI water, centrifuged in between washes and finally placed in an oven at 130° C. for 15 min. In a separate experiment this solution was left to react for 24 hours. Reaction time of one hour was insufficient (non-wetting in water but wetting in water-ethanol solutions above 50%). 24 hours reaction time resulted in the disappearance of the structural color.

Calcination of platelet-like structures in inert conditions results in the deposition of carbon black within the pores of the inverse opal particles. Presence of the carbon black reduces the surface area of the silica accessible for reaction with silanes. Initial attempts to modify the particles with 13F in the gas or liquid phase as described above showed limited degree of surface modification resulting in water and organic solvents capable of infiltration into the pores. Consequently binding of perfluoroalkane to the carbon deposit was attempted. First, the surface of the carbon black was activated by stirring about 100 mg of platelet-like structures in a mixture of sulfuric and nitric acid (3 ml and 1 ml respectively) at 70° C. for two hours. (In a separate experiment this time was extended to overnight.) This activation step was aimed to form carboxylated surface on the carbon black. Following this activation step the platelet-like structures were washed in two rounds of centrifugation (8K RPM) and redispersion in 1M HCl followed by three rounds of centrifugation and redispersion in DI water. The resulted powder was transferred into a glass vial and allowed to dry in the oven at 65° C. for 4 hours. After drying the powder was redispersed in 1 ml of dichloromethane (DCM). Then, 1 ml of DCM solution of N,N′-Dicyclohexylcarboxydiimide (DCC, 0.17 mmol) was added and the mixture was left for stirring for 30 min. After 30 min, a mixture of dimethylaminopyridine (DMAP, 5 mg) and 1,1,2,2-Tetrahydroperfluoro-dodecanol (17F—OH, 80 mg) in DCM and Novec-7500 (3M) (1:3) were added and the overall mixture was left to react for overnight at room temperature. Next, the dispersion was centrifuged at 14K RPM for two minutes and redispersed in Novec-7500. This sequence of centrifugation and redispersion was repeated with the following solvents: Novec-7500 (×2), Novec-7500:toluene (1:1, v/v, ×2), toluene (×2), toluene:DCM (1:1, v/v, ×2), DCM:methanol (1:1, v/v, ×2), and methanol (×2). Finally, the resulting powder was dried at 65° C. for overnight.

The procedure did not yield sufficient surface modification of platelet-like structures capable of preventing solvents to infiltrate the porous structure. Consequently, the procedure (a) described above was modified. It was found that longer drying time before the reaction (2 hours), fast transfer of the dried platelet-like structures into the vacuum chamber, placing a vial containing silane into the still-hot container with SHARDS, and longer reaction times (about two days) improve the efficiency. The resulted powder could be dispersed in a solvent- or water-based clear coats with no drastic change in their appearance.

### Example 8: Formation of Silica Inverse Photonic Balls

The aqueous dispersed phase was prepared by mixing 1 ml of colloidal dispersions (4.4 wt-%) with 0.5 ml of silica nanocrystals (5 wt-%). Emulsification of the aqueous mixture was performed using a T-junction dropmaker, with channels width of 50 micron, using Novec-7500 oil containing 0.5 wt-% triblock surfactant as a continuous phase. The emulsion was collected into 2 ml glass vials previously treated with 13 F. Surface modification of the vials was performed by placing a plastic tray with 100 vials into a vacuum chamber containing 4 small plastic caps filled with 50 pl of the silane each. The surface modification was required in order to avoid destabilization of the droplets upon contact with hydrophilic walls of the vial. Drying of the droplets was performed in a 45° C. oven or at RT occasionally shaking the container gently. The droplets are lighter than the oil phase prior to their complete drying and therefore have the tendency to float at the interface between the continuous phase and air and thus experiencing anisotropic drying environment. Thus, the shaking was done in order to minimize this effect. After complete drying, i.e. once the dispersed particles have no more tendency to float at the interface, an aliquot (20 pl) of photonic balls was deposited on a silicon substrate, calcined, and imaged using a Scanning Electron Microscope (SEM) and an optical microscope. The typical calcination conditions included temperature ramping up to 500° C. within 4 hours, isothermal stage for two hours and ramp down for four hours. Other calcination conditions were also studied, including faster ramp up and down (two hours each), variation in the temperature of the isothermal stage and presence of oxygen. Analogously to the results obtained with platelet-like structures, calcination of photonic balls at temperatures below 400° C. can result in incomplete removal of polystyrene colloids. Calcination at temperatures higher than 500° C. can cause shrinkage of the pores, and calcination in oxygen deficient conditions can result in the deposition of carbon black within the pores.

### Example 9: Formation of Silica Direct Photonic Balls

An aqueous dispersion of silica colloids (10 wt-%) was emulsified in a similar manner as described above using a T-junction dropmaker, with channels width of 50 micron, using Novec-7500 oil containing 0.5 wt-% triblock surfactant as a continuous phase. In addition, the emulsification was performed using a device with 100 micron channel opening. Stable formation of monodispersed droplets was performed at typical rates of 200-400 μl/hour for the continuous phase and 100-200 μl/hour for the dispersed phase for the T-junction device and 1-5 ml/hour for the continuous and dispersed phases for the device with 100 micron channel opening.

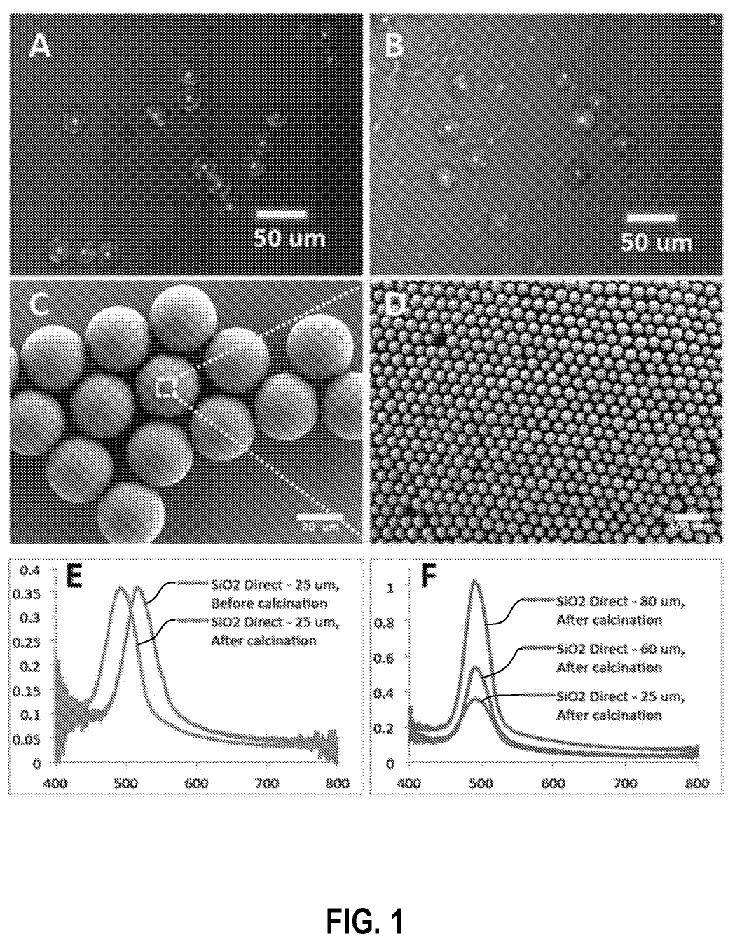

Upon drying the direct silica photonic balls were calcined. This calcination step resulted in a slight reduction in the lattice dimensions manifested in the blue shifted photonic peak (see FIG. 1 box E). FIG. 1 boxes A and B show, respectively, optical microscope images before and after calcination. FIG. 1 box C is an SEM image of the photonic balls before the heat treatment, and box D shows increased magnification of the marked area. FIG. 1 box E shows optical spectra of 25 micron photonic balls before and after the calcination recorded using a spectrometer coupled to a microscope. FIG. 1 box F shows optical spectra of photonic balls of three different sizes after the calcination.

### Example 10: Surface Modification

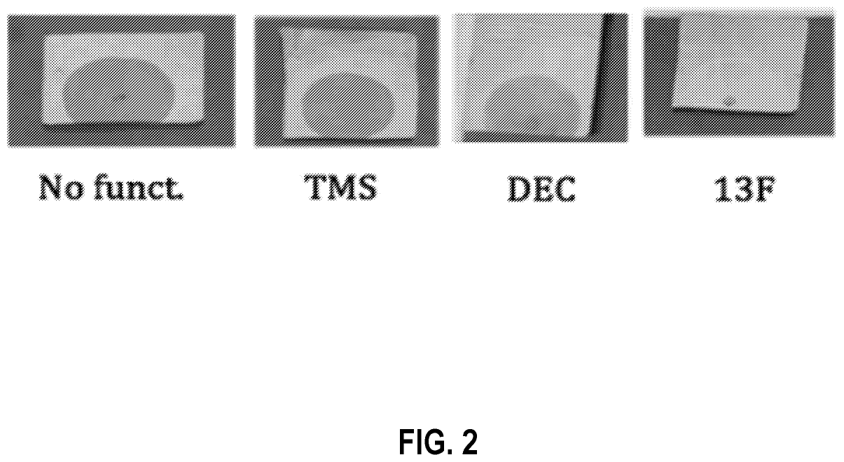

Infiltration of solvents or base-paints into the pores of the photonic structures may result in the red shift of the peak of the reflectance and decrease in the intensity of the reflected light. This is due to the increase in the average refractive index of the structure and reduced refractive index contrast. Surface modification of photonic structures with various functional groups was examined as a method to prevent infiltration of a solvent, in this example, a clear coat resin. As a model system, an inverse opal film was grown on a silicon substrate, which was cut into four pieces (FIG. 2). One piece was left unfunctionalized and served as a control sample (“no funct.”). The other pieces were functionalized with trichloromethylsilane (TMS), decyltrichlorosilane (DEC) and perfluorooctyltrichlorosilane (13F). A drop of a solvent-based clear coat resin was applied to each piece and the samples were cured. In the case of the control as well as functionalization with TMS, complete wetting was observed. In the case of functionalization with DEC the wetting was partial, and in the case of 13F no wetting occurred.

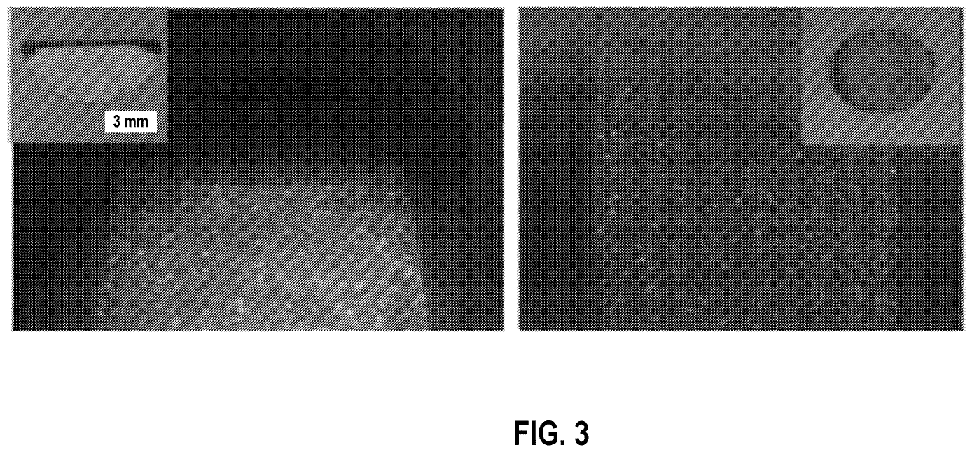

Consequently, two batches of platelet-like structures of green (FIG. 3, left) and blue colors (FIG. 3, right) were modified with 13 F. These samples were ground by rubbing through a 90 micron copper mesh which resulted in a collection of particles with a wide distribution of sizes, ranging from submicron up to a few tens of microns. The resulting powders were introduced into a solvent-based clearcoat formulation and drawn-down on test-cards. The dry powders deposited on microscope sticky tapes are shown as insets for comparison. The samples retained their color upon incorporation into the clearcoat and appeared similar to the dry powder. The samples appeared iridescent.

The above procedures may be utilized to surface modify other photonic structures such as photonic spheres, photonic crystals, photonic granules, opals, inverse opals and folded photonic structures.

In the foregoing description, numerous specific details are set forth, such as specific materials, dimensions, processes parameters, etc., to provide a thorough understanding of the embodiments of the present disclosure. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment, and such references mean “at least one”.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1-42. (canceled)

43. A liquid coating composition comprising:
a liquid medium; and
a structural colorant comprising photonic particles comprising a metal oxide, the photonic particles having silane functional groups on at least a portion of an external surface of the photonic particles.

44. The liquid coating composition of claim 43, wherein the photonic particles are selected from the group consisting of photonic spheres, photonic crystals, photonic granules, opals, inverse opals, folded photonic structures and platelet-like photonic structures.

45. The liquid coating composition of claim 43, wherein the photonic particles exhibit angle-dependent color or angle independent color.

46. The liquid coating composition of claim 43, wherein the silane functional groups are epoxy silanes, amino silanes, alkyl silanes, alkylhalosilanes or a combination thereof.

47. The liquid coating composition of claim 43, wherein the silane functional groups are silyl functional groups derived from reacting the photonic particles with a silane coupling agent.

48. The liquid coating composition of claim 47, wherein the silane coupling agent comprises an organo functional group and a hydrolysable functional group bonded directly or indirectly to silicone.

49. The liquid coating composition of claim 48, wherein the hydrolysable functional group is selected from alkoxy groups, aminoethyl trimethoxy silanes, aminopropyl trimethoxysilanes, glycidoxypropyl trimethoxy silanes or a combination thereof.

50. The liquid coating composition of claim 43, wherein the silane functional groups are alkylchlorosilanes, decyltrichlorosilanes, perfluorooctyltrichlorosilanes or a combination thereof.

51. The liquid coating composition of claim 43, further comprising organic binders, additives, organic pigments, inorganic pigments or a combination thereof, wherein the metal oxide is selected from the group consisting of silica, titania, alumina, zirconia, ceria, iron oxides, zinc oxide, indium oxide, tin oxide, chromium oxide and combinations thereof, and wherein the silane functional groups prevent or substantially prevent infiltration of the liquid medium into pores of the photonic particles.

52. The liquid coating composition of claim 43, wherein the reflective spectra of the liquid coating composition after storage for 24 hours at room temperature, standard atmosphere and relative humidity has a wavelength within 10% of the liquid coating composition prior to storage, and wherein the coating composition has a wavelength range selected from the group consisting of 380 to 450 nm, 451-495 nm, 496-570 nm, 571 to 590 nm, 591, 620 nm, and 621 to 750 nm.

53. The liquid coating composition of claim 43, wherein the liquid medium is an aqueous medium, an organic medium or a combination thereof.

54. The liquid coating composition of claim 43, wherein the particles have an average diameter of from about 0.5 μm to about 100 μm, an average porosity of from about 0.10 to about 0.80, and an average pore diameter of from about 50 nm to about 999 nm.

55. The liquid composition of claim 43, wherein the structural colorant comprises from about 60.0 wt % to about 99.9 wt % metal oxide, based on the total weight of the structural colorant.

56. The liquid composition of claim 43, wherein the structural colorant comprises from about 0.1 wt % to about 40.0 wt % of one or more light absorbers, based on the total weight of the particles.

57. A method of preparing photonic structures comprising reacting photonic structures comprising a metal oxide with a silane coupling agent such that each resultant photonic structure has silane functional groups on at least a portion of its external surface.

58. The method of claim 57, wherein the reacting is performed by mixing porous metal oxide particles with the silane coupling agent, and wherein the mixing comprises preparing a solution of the silane coupling agent and adding the solution to a slurry of the photonic structures.

59. The method of claim 58, wherein the solution comprises an aqueous solvent, an organic solvent, or a combination thereof.

60. A structural colorant comprising photonic particles comprising a metal oxide, the photonic particles having silane functional groups on at least a portion of an external surface of the photonic particles, wherein the photonic particles are selected from the group consisting of photonic spheres, photonic crystals, photonic granules, opals, inverse opals, folded photonic structures and platelet-like photonic structures, and wherein the photonic particles exhibit angle-dependent color or angle independent color.

61. A coating composition or coating derived from the liquid coating composition of claim 43.

62. An article of manufacture comprising a substrate and a coating of claim 61, wherein the substrate is an automotive part.
